(19) United States
(12) Patent Application Publication
(10) Pub. No.: US 2025/0162921 A1
(43) Pub. Date: May 22, 2025

(54) VITRIFICATION EQUIPMENT STARTING METHOD AND STARTING UNIT

(71) Applicant: KOREA HYDRO & NUCLEAR POWER CO., LTD, Gyeongju-si Gyeongsangbuk-do (KR)

(72) Inventors: Young Hwan HWANG, Daejeon (KR); Cheon Woo KIM, Daejeon (KR); Seok Ju HWANG, Daejeon (KR)

(73) Assignee: KOREA HYDRO & NUCLEAR POWER CO., LTD, Gyeongju-si Gyeongsangbuk-do (KR)

(21) Appl. No.: 18/721,558

(22) PCT Filed: May 15, 2023
(86) PCT No.: PCT/KR2023/006537

§ 371 Date: Jan. 30, 2025

(30) Foreign Application Priority Data
May 16, 2022 (KR) 10-2022-0059513

(51) Int. Cl. C03B 5/00; F23Q 13/00

(52) U.S. Cl. CPC C03B 5/005; F23Q 13/00

(57) ABSTRACT

Provided are a vitrification equipment starting method and starting unit. The vitrification equipment starting method includes: preparing an ignition module; putting the ignition module into a chamber of a low-temperature melting furnace; and performing an ignition operation inside the chamber of the low-temperature melting furnace using the ignition module connected to a high-frequency heating unit outside the low-temperature melting furnace, wherein the ignition module is put into the chamber of the low-temperature melting furnace in an initial state before a form thereof is changed and, when put into the chamber of the low-temperature melting furnace, becomes a variable state in which the form thereof is changed from the initial state and performs the ignition operation.

### TECHNICAL FIELD

The present disclosure relates to a vitrification equipment starting unit and starting method.

### BACKGROUND ART

Ignition using a titanium (Ti) ring is essential to start a low-temperature melting furnace in relation to the operation of vitrification equipment. Titanium rings that are standardized to a circular shape are not easy to respond to variable situations (e.g. passing through a narrow gate, etc.). Therefore, they have limitations of their own specifications, causing the problem of low efficiency in the operation of the low-temperature melting furnace.

### DISCLOSURE

### Technical Problem

Aspects of the present disclosure provide a vitrification equipment starting unit and starting method which has a complex structure capable of variable operation rather than a standardized titanium ring in relation to the operation of vitrification equipment.

Aspects of the present disclosure also provide a vitrification equipment starting unit and starting method which enables a titanium ring having a complex structure to move in a contracted form when passing through a relatively narrow gate of a low-temperature melting furnace and to be placed in an expanded form inside the low-temperature melting furnace.

Aspects of the present disclosure also provide a vitrification equipment starting unit and starting method which can efficiently achieve ignition in a low-temperature melting furnace by applying a process of appropriately adjusting a radius of a titanium ring based on electromagnetic interpretation.

However, aspects of the present disclosure are not restricted to the one set forth herein. The above and other aspects of the present disclosure will become more apparent to one of ordinary skill in the art to which the present disclosure pertains by referencing the detailed description of the present disclosure given below.

### Technical Solution

According to an aspect of the present disclosure, there is provided a vitrification equipment starting method including: preparing an ignition module; putting the ignition module into a chamber of a low-temperature melting furnace; and performing an ignition operation inside the chamber of the low-temperature melting furnace using the ignition module connected to a high-frequency heating unit outside the low-temperature melting furnace, wherein the ignition module is put into the chamber of the low-temperature melting furnace in an initial state before a form thereof is changed and, when put into the chamber of the low-temperature melting furnace, becomes a variable state in which the form thereof is changed from the initial state and performs the ignition operation.

In addition, the low-temperature melting furnace includes a gate which connects the inside and the outside, the ignition module is put into the low-temperature melting furnace in the initial state via the gate, and the variable state of the ignition module includes a form expanded larger than a volume of the ignition module in the initial state.

In addition, a first volume value of the ignition module, which is a volume value in the initial state, has a value equal to or less than an area value of the gate, and a second volume value of the ignition module, which is a volume value in the variable state, has a value exceeding the area value of the gate.

In addition, the ignition module includes: an ignition body in the initial state or the variable state; and a storage body accommodating the ignition body in the initial state therein so that the ignition body maintains the initial state.

In addition, the ignition body of the ignition module includes a plurality of joint portions, a rotating portion rotating the joint portions, and an elastic portion fitted over the joint portions and at least a part of the rotating portion to surround an outer surface of the joint portions and at least a part of the rotating portion and provide an elastic restoring force to each of the joint portions of the rotating portion.

In addition, the storage body of the ignition module is at least partially destroyed by external force applied in a process of being put into the gate of the low-temperature melting furnace, and the storage body of the ignition module becomes the variable state as the storage body is discharged to the outside of the storage body based on the destruction of the storage body.

In addition, the storage body includes any one of rubber, glass, and plastic materials.

According to another aspect of the present disclosure, there is provided a vitrification equipment starting unit including an ignition module put into a chamber of a low-temperature melting furnace to perform an ignition operation, wherein the ignition module is put into the chamber of the low-temperature melting furnace in an initial state before a form thereof is changed and, when put into the chamber of the low-temperature melting furnace, becomes a variable state in which the form thereof is changed from the initial state, performs the ignition operation in contact with melt inside the low-temperature melting furnace, and performs the ignition operation inside the chamber of the low-temperature melting furnace while being connected to a high-frequency heating unit outside the low-temperature melting furnace.

### Advantageous Effects

A vitrification equipment starting unit and starting method according to the present disclosure provides at least one of the following advantages.

The present disclosure provides a titanium ring capable of variable operation rather than a standardized titanium ring in relation to the operation of vitrification equipment. Therefore, efficient operation of the vitrification equipment is possible.

In particular, the variable titanium ring can move in a contracted form when passing through a relatively narrow gate of a low-temperature melting furnace and can be placed in an expanded form inside the low-temperature melting furnace. Therefore, efficient operation of the vitrification equipment is possible.

In addition, it is possible to provide a vitrification equipment starting unit and starting method which can efficiently achieve ignition in the low-temperature melting furnace by applying a process of appropriately adjusting a radius of the titanium ring based on electromagnetic interpretation.

### DESCRIPTION OF DRAWINGS

FIG. 1 is a flowchart sequentially illustrating a vitrification equipment starting method according to an embodiment of the present disclosure;

FIG. 2 is a diagram illustrating a vitrification equipment starting unit according to an embodiment of the present disclosure;

FIGS. 3 and 4 are diagrams illustrating components according to FIG. 2;

FIG. 5 is a diagram illustrating a process in which the components according to FIG. 2 are inserted; and

FIG. 6 is a diagram illustrating a partial structure of a component according to FIG. 2.

### MODE FOR INVENTION

Hereinafter, exemplary embodiments of the present disclosure will be described in further detail with reference to the attached drawings. Advantages and features of the present disclosure and methods of accomplishing the same may be understood more readily by reference to the following detailed description of exemplary embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the present disclosure to those skilled in the art, and the present disclosure will only be defined by the appended claims. Like reference numerals refer to like elements throughout the specification.

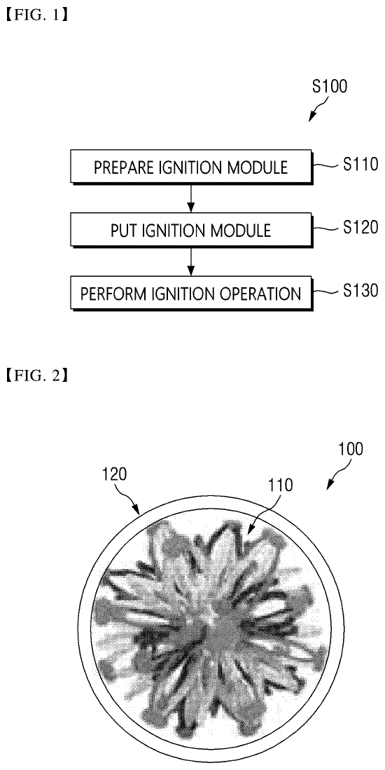

Referring to FIG. 1, in a vitrification equipment starting method S100 according to an embodiment of the present disclosure, first, an ignition module 100 is prepared. The prepared ignition module 100 is put into a chamber of a low-temperature melting furnace 50 to start or restart the low-temperature melting.

In addition, the ignition module 100 is connected to a high-frequency heating unit outside the low-temperature melting furnace 50 and performs an ignition operation inside the chamber of the low-temperature melting furnace 50.

The ignition module 100 is put into the chamber of the low-temperature melting furnace 50 in an initial state before its form is changed. In addition, when put into the chamber of the low-temperature melting furnace 50, it becomes a variable state in which its form is changed from the initial state.

Here, the ignition module 100 put into the low-temperature melting furnace 50 contacts melt inside the low-temperature melting furnace 50 in the variable state and performs the ignition operation.

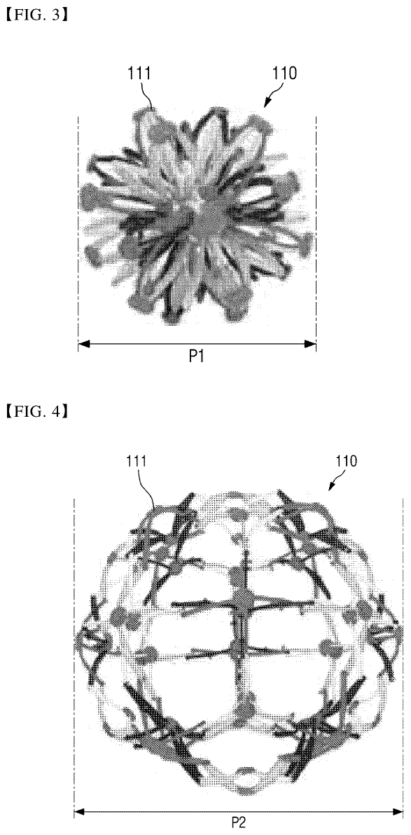

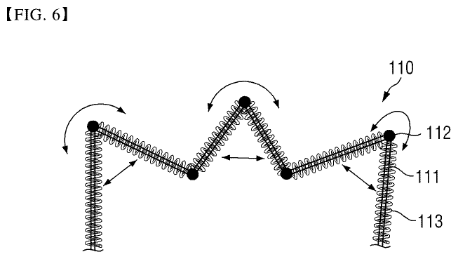

Referring to FIGS. 2 through 6, a vitrification equipment starting unit according to an embodiment of the present disclosure includes an ignition module 100. The ignition module 100 includes an ignition body 110 and a storage body 120. The ignition body 110 includes a joint portion 111, a rotating portion 112, and an elastic portion 113 (see FIGS. 2 and 6).

The ignition module 100 is put into the chamber of the low-temperature melting furnace 50. It is connected to a high-frequency heating unit outside the low-temperature melting furnace 50. The ignition module 100 performs an ignition operation inside the chamber of the low-temperature melting furnace 50 based on the operation of the high-frequency heating unit (see FIGS. 2 through 4).

Here, the low-temperature melting furnace 50 includes a gate 50H which connects the inside and the outside. The ignition module 100 is put into the low-temperature melting furnace 50 in the initial state via the gate 50H (see FIGS. 2 and 4).

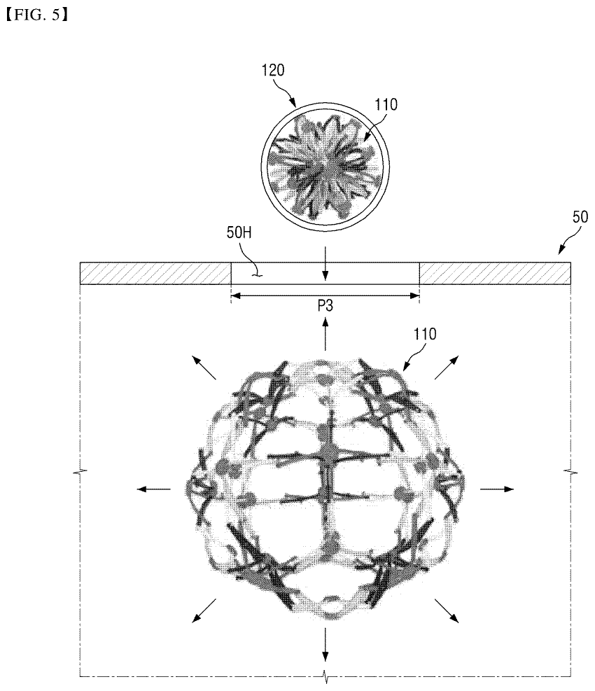

The variable state of the ignition module 100 includes a form expanded larger than the volume of the ignition module 100 in the initial state. A first volume value P1 of the ignition module 100, which is a volume value in the initial state, has a value equal to or less than an area value P3 of the gate 50H (see FIG. 5).

In addition, a second volume value P2 of the ignition module 100, which is a volume value in the variable state, has a value exceeding the area value P3 of the gate 50H. The ignition body 110 of the ignition module 100 is in the initial state or the variable state (see FIGS. 3 and 4).

The storage body 120 of the ignition module 100 accommodates the ignition body 110 in the initial state therein so that the ignition body 110 maintains the initial state (see FIG. 2).

The joint portion 111 of the ignition body 110 is provided in plural numbers, and the joint portions 111 are complexly positioned adjacent to each other. The rotating portion 112 of the ignition body 110 rotates the joint portions 111 (see FIG. 6).

The elastic portion 113 of the ignition body 110 is fitted over the joint portions 111 and at least a part of the rotating portion 112 to surround an outer surface of the joint portions and at least a part of the rotating portion to provide an elastic restoring force to each of the joint portions 111 on the rotating portion 112 (see FIG. 6).

The storage body 120 of the ignition module 100 is at least partially destroyed based on external force or heat in a process of being put into the gate 50H of the low-temperature melting furnace 50. The ignition body 110 of the ignition module 100 becomes the variable state as it is discharged to the outside of the storage body 120 based on the destruction of the storage body 120 (see FIG. 5).

The storage body 120 includes any one of rubber, glass, and plastic materials. For example, when made of the rubber material, the storage body 120 is at least partially torn through the destruction. When made of the glass or plastic material, the storage body 120 is at least partially broken by external force.

While the present disclosure has been particularly shown and described with reference to exemplary embodiments thereof, it will be understood by those of ordinary skill in the art that various changes in form and detail may be made therein without departing from the spirit and scope of the present disclosure as defined by the following claims. The exemplary embodiments should be considered in a descriptive sense only and not for purposes of limitation.

1. A vitrification equipment starting method comprising:
preparing an ignition module;
putting the ignition module into a chamber of a low-temperature melting furnace; and
performing an ignition operation inside the chamber of the low-temperature melting furnace using the ignition module connected to a high-frequency heating unit outside the low-temperature melting furnace,
wherein the ignition module is put into the chamber of the low-temperature melting furnace in an initial state before a form thereof is changed and, when put into the chamber of the low-temperature melting furnace, becomes a variable state in which the form thereof is changed from the initial state and performs the ignition operation.

2. The method of claim 1, wherein the low-temperature melting furnace comprises a gate which connects the inside and the outside, the ignition module is put into the low-temperature melting furnace in the initial state via the gate, and the variable state of the ignition module comprises a form expanded larger than a volume of the ignition module in the initial state.

3. The method of claim 2, wherein a first volume value of the ignition module, which is a volume value in the initial state, has a value equal to or less than an area value of the gate, and a second volume value of the ignition module, which is a volume value in the variable state, has a value exceeding the area value of the gate.

4. The method of claim 2, wherein the ignition module comprises:
an ignition body in the initial state or the variable state; and
a storage body accommodating the ignition body in the initial state therein so that the ignition body maintains the initial state.

5. The method of claim 4, wherein the ignition body of the ignition module comprises a plurality of joint portions, a rotating portion rotating the joint portions, and an elastic portion fitted over the joint portions and at least a part of the rotating portion to surround an outer surface of the joint portions and at least a part of the rotating portion and provide an elastic restoring force to each of the joint portions of the rotating portion.

6. The method of claim 4, wherein the storage body of the ignition module is at least partially destroyed by external force applied in a process of being put into the gate of the low-temperature melting furnace, and the ignition body of the ignition module becomes the variable state as the ignition body is discharged to the outside of the storage body based on the destruction of the storage body.

7. The method of claim 6, wherein the storage body comprises any one of rubber, glass, and plastic materials.

8. A vitrification equipment starting unit comprising an ignition module put into a chamber of a low-temperature melting furnace to perform an ignition operation, wherein the ignition module is put into the chamber of the low-temperature melting furnace in an initial state before a form thereof is changed and, when put into the chamber of the low-temperature melting furnace, becomes a variable state in which the form thereof is changed from the initial state, performs the ignition operation in contact with melt inside the low-temperature melting furnace, and performs the ignition operation inside the chamber of the low-temperature melting furnace while being connected to a high-frequency heating unit outside the low-temperature melting furnace.
